(19) United States
(12) Patent Application Publication
(10) Pub. No.: US 2013/0163112 A1
(43) Pub. Date: Jun. 27, 2013

(54) BASE ASSEMBLY AND RECORDING DISK DRIVING DEVICE INCLUDING THE SAME

(71) Applicant: Il Geun JEON, Hwaseong (KR)

(72) Inventor: Il Geun JEON, Hwaseong (KR)

(73) Assignee: SAMSUNG ELECTRO-MECHANICS CO., LTD., Suwon (KR)

(21) Appl. No.: 13/402,338

(22) Filed: Feb. 22, 2012

(30) Foreign Application Priority Data
Dec. 23, 2011 (KR) 10-2011-0141672

(51) Int. Cl. G11B 33/14; G11B 21/02; G11B 17/02

(52) U.S. Cl. 360/75; 360/99.08; 360/97.12; G9B/17.002; G9B/33.035; G9B/21.003

(57) ABSTRACT

There is provided a base assembly including: a bracket device connected to a head assembly in order to drive the head assembly for reading information from a disk and including an elastic member provided on one surface thereof, the elastic member having a terminal disposed in an inner portion thereof and connected to a main circuit board; and a press base formed by press processing and having an opening part into which the elastic member is inserted, wherein the press base includes an elastic support part forming the opening part and extended in a direction into which the bracket device is inserted to thereby increase a contact area with the elastic member.

### CROSS-REFERENCE TO RELATED APPLICATIONS

This application claims the priority of Korean Patent Application No. 10-2011-0141672 filed on Dec. 23, 2011, in the Korean Intellectual Property Office, the disclosure of which is incorporated herein by reference.

### BACKGROUND OF THE INVENTION

1. Field of the Invention

The present invention relates to a base assembly and a recoding disk driving device including the same.

2. Description of the Related Art

A hard disk drive (HDD), a computer information storage device, reads data stored on a disk or writes data to the disk using a magnetic head.

In this hard disk drive, a base is installed with a head driver, that is, a head stack assembly (HSA), capable of altering a position of the magnetic head relative to the disk. The magnetic head performs its function while moving to a desired position in a state in which it is suspended at a predetermined height above a writing surface of the disk by the head driver.

According to the related art, in manufacturing a base provided in the hard disk drive, a post-processing scheme of die-casting aluminum (Al) and then removing burrs or the like, generated due to the die-casting, has been used.

However, in the die-casting scheme according to the related art, since a process of injecting molten aluminum (Al) into a die to form a base is performed, high temperature and pressure are required, such that a large amount of energy is required and a process time is increased.

Further, even in terms of a lifespan of a die-casting mold, there is a limitation in manufacturing a large number of bases using a single mold, and a base manufactured by the die-casting process has poor dimensional precision.

Therefore, in order to solve defects in the die-casting process, the base has been manufactured by press processing. However, in the case of press processing, the thickness of the base may be limited to be uniform due to characteristics of plate bending and cutting processes.

Meanwhile, the base has a head stack assembly (HAS) mounted therein, the head stack assembly including a head for reading data from the disk and writing the data to the disk. In addition, the base has a bracket device installed therein, the bracket device electrically connecting the head stack assembly and a main circuit board to each other.

In addition, the base has an opening part into which a lower end portion of the bracket device is inserted. The opening part of the base is also formed by press processing, in which is the plate is pressed and bent.

Therefore, when the lower end portion of the bracket device is insertedly installed in the opening part, permanent deformation occurs in the base, such that sealing is not appropriately made at the time of installation of the bracket device. That is, a portion of the base in which the opening part is formed may be deformed, such that sealing from the outside is not maintained at the time of the installation of the bracket device.

For reference, a recoding disk driving device including a base is disclosed in Japanese Patent Laid-open Publication No. 2000-245122 and Japanese Patent Laid-open Publication No. 2002-335084.

### SUMMARY OF THE INVENTION

An aspect of the present invention provides a base assembly capable of reducing deformation of a base at the time of installation of a bracket device, and a recording disk driving device including the same.

According to an aspect of the present invention, there is provided a base assembly including: a bracket device connected to a head assembly in order to drive the head assembly for reading information from a disk and including an elastic member provided on one surface thereof, the elastic member having a terminal disposed in an inner portion thereof and connected to a main circuit board; and a press base formed by press processing and having an opening part into which the elastic member is inserted, wherein the press base includes an elastic support part forming the opening part and extended in a direction into which the bracket device is inserted to thereby increase a contact area with the elastic member.

The elastic support part may be formed by burring.

An upper end portion of the elastic support part forming the opening part may be rounded to allow the elastic member to be easily inserted thereinto.

The press base may include a screw coupling part disposed to be adjacent to the opening part and fixing the bracket device.

The elastic member may be closely adhered to an inner surface of the elastic support part by compression force due to elastic deformation of the elastic support part in order to maintain air tightness.

According to another aspect of the present invention, there is provided a recording disk driving device including: a base assembly including a bracket device having an elastic member provided on one surface thereof and a press base having an elastic support part extended in a direction into which the bracket device is inserted to thereby increase a contact area with the elastic member, the elastic member having a terminal disposed in an inner portion thereof and connected to a main circuit board; a head stack assembly connected to the bracket device and rotatably installed on the press base; and a spindle motor installed on the press base and having at least one disk mounted thereon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a base assembly according to an embodiment of the present invention;

FIG. 2 is an exploded perspective view showing a base assembly according to an embodiment of the present invention;

FIG. 3 is an enlarged view showing part A of FIG. 2;

FIG. 4 is a bottom view showing part A of FIG. 2; and

FIG. 5 is a schematic exploded perspective view showing a recording disk driving device according to an embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that a detailed description of the known art, related to the present invention, may obscure the gist of the present invention, a detailed description thereof will be omitted.

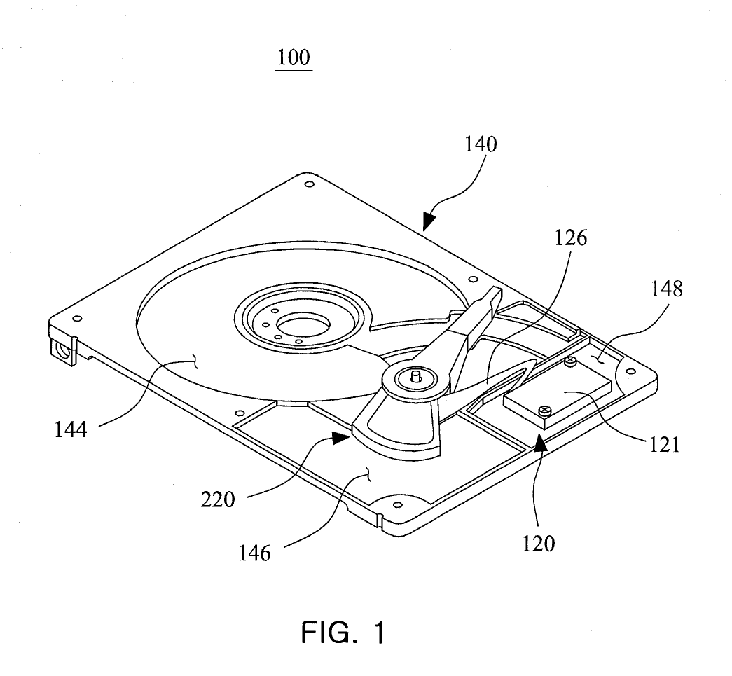

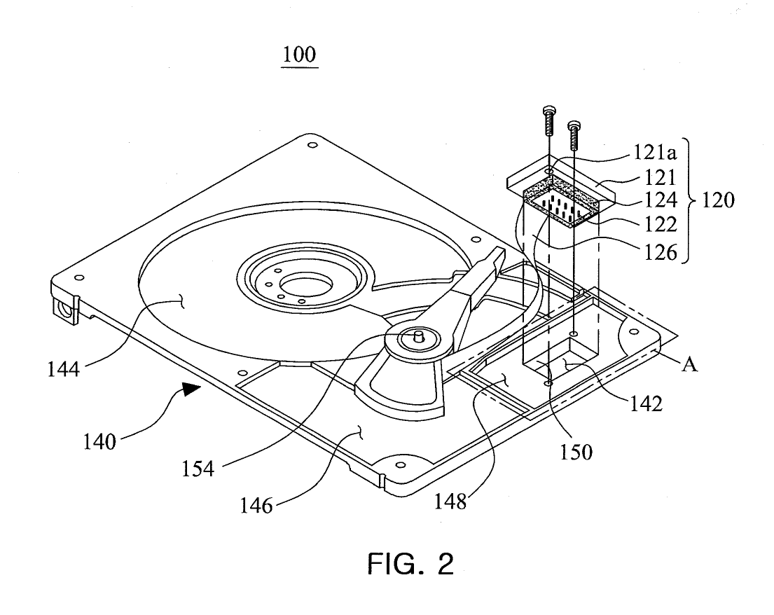

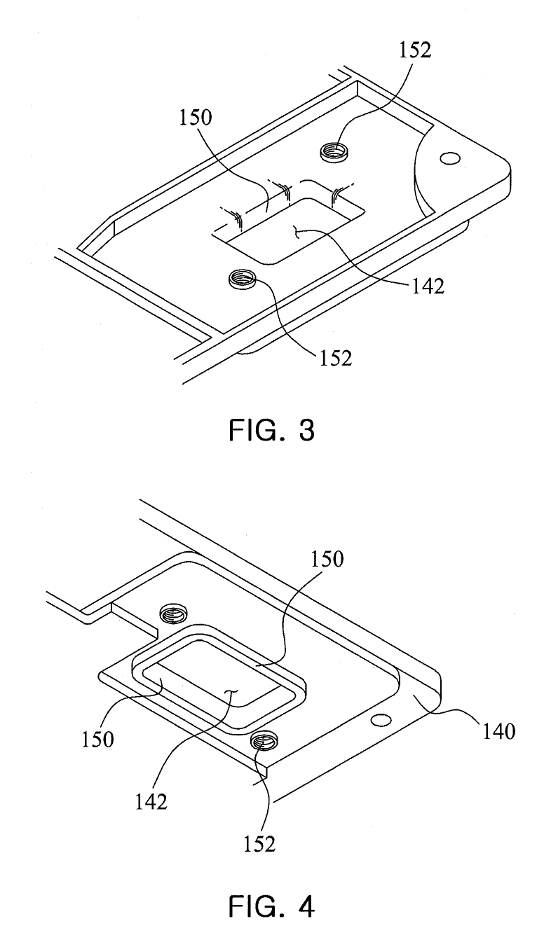

FIG. 1 is a schematic perspective view showing a base assembly according to an embodiment of the present invention; FIG. 2 is an exploded perspective view showing a base assembly according to an embodiment of the present invention; FIG. 3 is an enlarged view showing part A of FIG. 2; and FIG. 4 is a bottom view showing part A of FIG. 2.

Referring to FIGS. 1 through 4, a base assembly 100 according to an embodiment of the present invention may include a bracket device 120 and a press base 140.

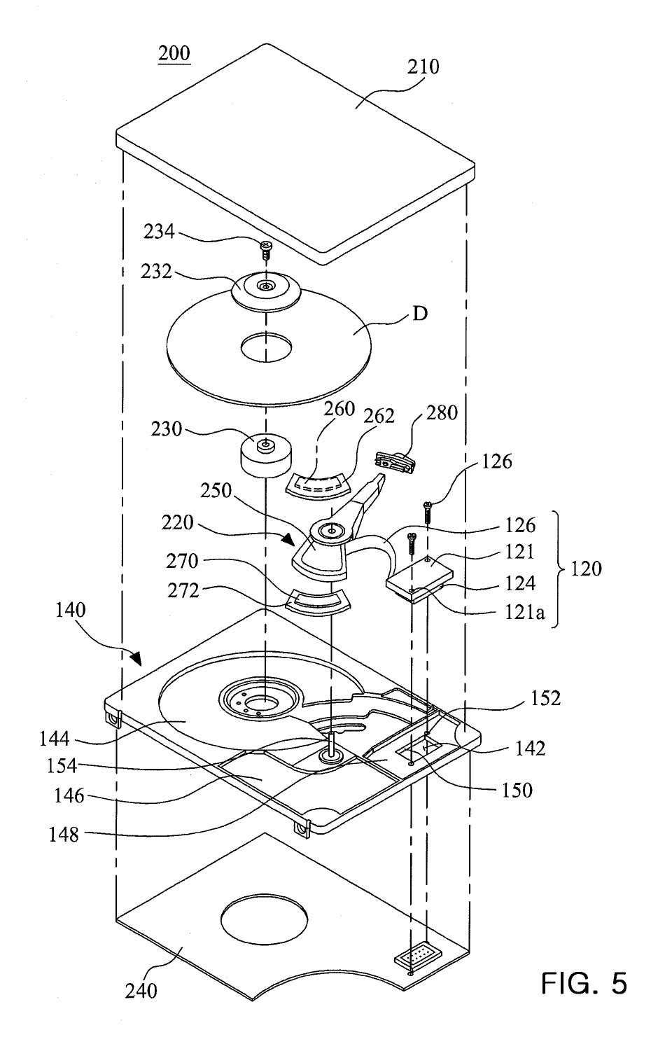

The bracket device 120 may be connected to ahead stack assembly (HSA) 220 to drive the HSA 220 for reading information from a disk D (See FIG. 5) and may include an elastic member 124 provided on one surface thereof. The elastic member 124 may have a terminal 122 disposed in an inner portion thereof and connected to a main circuit board 240 (See FIG. 5).

Meanwhile, the bracket device 120 may include a plate part 121 having a rectangular plate shape, the terminal 122 protruding from a bottom surface of the plate part 121, the elastic member 124 disposed around the terminal 122 such that the terminal 122 is disposed in the inner portion thereof, and a connection part 126 extending from the plate part 121 to thereby be connected to the above-mentioned head stack assembly 220.

Meanwhile, at least two edges of the plate part 121 may be provided with screw holes 121a for fixedly installing the bracket device 120.

The press base 140 may be formed by press processing and be provided with an opening part 142 into which the elastic member 124 is inserted.

In a recording disk driving device 200 (See FIG. 5), the press base 140 may configure a housing forming an exterior together with a cover 210 and may include a disk mounting part 144, a head stack assembly mounting part 146, and a bracket device mounting part 148.

Meanwhile, after basic shapes of the disk mounting part 144, the head stack assembly mounting part 146, and the bracket device mounting part 148 are manufactured by a pressing process, a final shape of the press base 140 may be formed by an additional bending or cutting process.

That is, the press base 140 may be manufactured by a single pressing process or by a single pressing process and an additional process, unlike the related art base manufactured in a post-processing scheme in which aluminum (Al) is die-cast and burrs or the like generated due to the die-casting process are then removed.

That is, the disk mounting part 144, the head stack assembly mounting part 146, and the bracket device mounting part 148 of the press base 140 may be formed by disposing a cold rolled steel sheet (SPCC, SPCE, or the like), a hot rolled steel sheet, a stainless steel sheet, a lightweight alloy steel sheet such as a boron or magnesium alloy, or the like, in a press mold and pressing it at a predetermined pressure.

As described above, since the press base 140 is manufactured by press processing, a process time and energy consumption are significantly reduced, whereby a manufacturing yield may be improved.

Meanwhile, the disk mounting part 144 may have the disk D disposed thereon and generally have a circular shape corresponding to the shape of the disk D.

More specifically, the disk mounting part 144 may be formed by depressing a partial region of the press base 140 downwardly in an axial direction to thereby receive the disk D therein.

In addition, the head stack assembly mounting part 146 may be disposed to be adjacent to the disk mounting part 144 and have the HSA 220 (See FIG. 5) mounted thereon.

Further, the bracket device mounting part 148 may be disposed to be adjacent to the head stack assembly mounting part 146 and have the bracket device 120 installed therein.

Meanwhile, the bracket device mounting part 148 may be provided with the opening part 142 into which the elastic member 124 is inserted.

More specifically, the bracket device mounting part 148 may be provided with an elastic support part 150 extending in a direction into which the bracket device 120 is inserted to thereby increase a contact area with the elastic member 124.

In addition, the elastic support part 150 may be protruded toward a bottom surface of the press base 140 and be formed by burring, thereby forming the above-mentioned opening part 142.

Further, an upper end portion of the elastic support part 150 forming the opening part 142 may be rounded to allow the elastic member 124 to be easily inserted thereinto.

Meanwhile, the shape of the opening part 142 may correspond to that of the elastic member 124. According to the present embodiment, the opening part 142 may have a rectangular shape. However, the shape of the opening part 142 is not limited thereto but may be variously changed.

Here, the terminal 122 and the elastic member 124 of the bracket device 120 are inserted into the opening part 142. At this time, the elastic member 124 contacts an inner surface of the elastic support part 150.

In addition, the terminal 122 disposed in the inner portion of the elastic member 124 may be exposed to the bottom surface of the press base 140 through the opening part 142.

Meanwhile, since the elastic support part 150 is formed by burring and is protruded toward the bottom surface of the press base 140 as described above, the contact area with the elastic member 124 may be increased.

In addition, the opening part 142 has a smaller size than that of an outer surface of the elastic member 124, such that when the elastic member 124 is inserted into the opening part 142, the elastic support part 150 may press the elastic member 124.

That is, the elastic member 124 may be closely adhered to the inner surface of the elastic support part 150 by compression force due to elastic deformation of the elastic support part 150 in order to maintain air tightness.

As described above, the elastic support part 150 is formed by burring, such that a contact area between the elastic member 124 and the press base 140 may be increased. In other words, the contact area between the press base 140 and the elastic member 124 may be increased as compared to a case in which the elastic support part 150 is not formed. Therefore, when the elastic member 124 is inserted into the opening part 142, permanent deformation of the press base 140 may be prevented.

As a result, even in the case in which the bracket device 120 is installed in the press base 140, sealing from the outside may be maintained.

In addition, precision of an assembled surface of the press base 140 and the bracket device 120 may be improved by the elastic support part 150.

In addition, the press base 140 may be provided with screw coupling parts 152 disposed to be adjacent to the opening part 142 and fixing the bracket device 120.

That is, the bracket device mounting part 148 of the press base 140 may include the screw coupling parts 152 formed therein in order to fixedly install the bracket device 120. In addition, the screw coupling parts 152 may be disposed to be adjacent to the opening part 142.

As described above, since the opening part 142 into which the elastic member 124 of the bracket device 120 is inserted is formed by the elastic support part 150, the elastic member 124 and the elastic support part 150 may be in contact with each other.

Therefore, since the elastic member 124 contacts the elastic support part 150, the contact area between the elastic member 124 and the press base 140 may be increased as compared to the case in which the elastic support part 150 is not provided.

Therefore, when the elastic member 124 is inserted into the opening part 142, the deformation of the press base 140 is suppressed, whereby the sealing effect may be ensured.

In other words, the elastic support part 150 is formed by burring, such that the elastic member 124 contacts the elastic support part 150 at the time of inserting the elastic member 124 into the opening part 142, whereby the deformation of the press base 140 may be suppressed.

Hereinafter, a recording disk driving device according to an embodiment of the present invention will be described with reference to the accompanying drawings.

FIG. 5 is a schematic exploded perspective view showing a recording disk driving device according to an embodiment of the present invention.

Referring to FIG. 5, the recording disk driving device 200 according to this embodiment of the present invention may include the base assembly 100, the head stack assembly (HSA) 220, a spindle motor 230, and the main circuit board 240.

Meanwhile, the base assembly 100 may include the bracket device 120 and the press base 140.

Further, in FIG. 5, reference numerals of the components of the base assembly 100 are not described in detail. Therefore, the reference numerals will be described with reference to FIGS. 1 through 4.

The bracket device 120 may be connected to the head stack assembly (HSA) 220 in order to drive the HSA 220 for reading information from the disk D and include the elastic member 124 provided on one surface thereof. Here, the elastic member 124 has the terminal 122 disposed in the inner portion thereof and connected to the main circuit board 240.

Meanwhile, the bracket device 120 may include the plate part 121 having a rectangular plate shape, the terminal 122 protruding from the bottom surface of the plate part 121, the elastic member 124 disposed around the terminal 122 such that the terminal 122 is disposed in the inner portion thereof, and the connection part 126 extending from the plate part 121 to thereby be connected to the head stack assembly 220.

Meanwhile, at least two edges of the plate part 121 may be provided with the screw holes 121a for fixedly installing the bracket device 120.

The press base 140 may be formed by press processing and be provided with the opening part 142 into which the elastic member 124 is inserted.

In the recording disk driving device 200, the press base 140 may configure a housing forming an exterior together with a cover 210, and may include the disk mounting part 144, the head stack assembly mounting part 146, and the bracket device mounting part 148.

Meanwhile, after basic shapes of the disk mounting part 144, the head stack assembly mounting part 146, and the bracket device mounting part 148 are manufactured by a pressing process, a final shape of the press base 140 may be formed by an additional bending or cutting process.

That is, the press base 140 may be manufactured by a single pressing process or by a single pressing process and an additional process, unlike the related art base manufactured in a post-processing scheme in which aluminum (Al) is die-cast and burrs or the like generated due to the die-casting process are then removed.

That is, the disk mounting part 144, the head stack assembly mounting part 146, and the bracket device mounting part 148 of the press base 140 may be formed by disposing a cold rolled steel sheet (SPCC, SPCE, or the like), a hot rolled steel sheet, a stainless steel sheet, a lightweight alloy steel sheet such as a boron or magnesium alloy, or the like, in a press mold and pressing it at a predetermined pressure.

As described above, since the press base 140 is manufactured by press processing, a process time and energy consumption are significantly reduced, whereby a manufacturing yield may be improved.

Meanwhile, the disk mounting part 144 may have the disk D disposed thereon and generally have a circular shape corresponding to the shape of the disk D.

More specifically, the disk mounting part 144 may be formed by depressing a partial region of the press base 140 downwardly in an axial direction to thereby receive the disk D therein.

In addition, the head stack assembly mounting part 146 may be disposed to be adjacent to the disk mounting part 144 and have the HSA 220 mounted thereon.

Further, the bracket device mounting part 148 may be disposed to be adjacent to the head stack assembly mounting part 146 and have the bracket device 120 installed therein.

Meanwhile, the bracket device mounting part 148 may be provided with the opening part 142 into which the elastic member 124 is inserted.

More specifically, the bracket device mounting part 148 may be provided with the elastic support part 150 extending in a direction into which the bracket device 120 is inserted to thereby increase a contact area with the elastic member 124.

In addition, the elastic support part 150 may be protruded toward the bottom surface of the press base 140 and be formed by burring, thereby forming the above-mentioned opening part 142.

Further, the upper end portion of the elastic support part 150 forming the opening part 142 may be rounded to allow the elastic member 124 to be easily inserted thereinto.

Meanwhile, the shape of the opening part 142 may correspond to that of the elastic member 124. According to the present embodiment, the opening part 142 may have a rectangular shape. However, the shape of the opening part 142 is not limited thereto but may be variously changed.

Here, the terminal 122 and the elastic member 124 of the bracket device 120 are inserted into the opening part 142. At this time, the elastic member 124 contacts the inner surface of the elastic support part 150.

In addition, the terminal 122 disposed in the inner portion of the elastic member 124 may be exposed to the bottom surface of the press base 140 through the opening part 142.

Meanwhile, since the elastic support part 150 is formed by burring and is protruded toward the bottom surface of the press base 140 as described above, the contact area with the elastic member 124 may be increased.

In addition, the opening part 142 has a smaller size than that of an outer surface of the elastic member 124, such that when the elastic member 124 is inserted into the opening part 142, the elastic support part 150 may press the elastic member 124.

That is, the elastic member 124 may be closely adhered to the inner surface of the elastic support part 150 by compression force due to elastic deformation of the elastic support part 150 in order to maintain air tightness.

As described above, the elastic support part 150 is formed by burring, such that the contact area between the elastic member 124 and the press base 140 may be increased. In other words, the contact area between the press base 140 and the elastic member 124 may be increased as compared to a case in which the elastic support part 150 is not formed. Therefore, when the elastic member 124 is inserted into the opening part 142, permanent deformation of the press base 140 may be prevented.

As a result, even in the case in which the bracket device 120 is installed in the press base 140, sealing from the outside may be maintained.

In addition, precision of an assembled surface of the press base 140 and the bracket device 120 may be improved by the elastic support part 150.

In addition, the press base 140 may be provided with the screw coupling parts 152 disposed to be adjacent to the opening part 142 and fixing the bracket device 120.

That is, the bracket device mounting part 148 of the press base 140 may include the screw coupling parts 152 formed therein in order to fixedly install the bracket device 120. In addition, the screw coupling parts 152 may be disposed to be adjacent to the opening part 142.

The head stack assembly 220 may have a magnetic head mounted thereon and move the magnetic head to a predetermined position to thereby write data to the disk D or read data written on the disk D.

In addition, the head stack assembly 220 may move the magnetic head to a predetermined position of the disk 1D by a voice coil motor (VCM) including a coil 250 and upper and lower magnets 260 and 270.

Here, the upper and lower magnets 260 and 270 disposed on upper and lower portions of the coil 250 provided in the VCM may be coupled to upper and lower yokes 262 and 272, respectively, in order to increase magnetic flux density and be fixed to the press base 140.

The VCM may be controlled by a servo control system and rotate the head stack assembly 220 around a pivot shaft 154 according to the Fleming's left hand rule by interaction between current input by the coil 250 of the VCM and magnetic fields formed by the upper and lower magnets 260 and 270.

Here, the operation of the head stack assembly 220 will be schematically described. First, when an operation start command is input and the disk D starts to rotate, the VCM rotates a swing arm in a counterclockwise direction to thereby move the magnetic head onto the writing surface of the disk D.

Further, when an operation stop command is input, the VCM rotates the swing arm in a clockwise direction to thereby allow the magnetic head to deviate from the disk D.

Meanwhile, the magnetic head deviating from the writing surface of the disk D is parked on a ramp 280 disposed outside the disk D.

Here, the ramp 280 may allow the magnetic head to be spaced apart from the disk D by a predetermined interval in the case in which the magnetic head moves to the disk D, while simultaneously parking the magnetic head, whereby the data of the disk D may be stably read.

Meanwhile, the head stack assembly 220 may be electrically connected to the main circuit board 240 disposed on the bottom surface of the press base 140 so as to rotate the swing arm by providing driving force to the VCM.

It may be implemented through the bracket device 120 including the terminal 124. That is, the main circuit board 240 and the head stack assembly 220 may be electrically connected to each other by the bracket device 120.

Meanwhile, the spindle motor 230 for rotating the disk D may be fixedly installed at the center of the disk mounting part 144 of the press base 140.

The disk D may be mounted on the spindle motor 230 to thereby be rotated by the driving of the spindle motor 230, and have the writing surface on which data is written.

In addition, a clamp 232 may be coupled to an upper end portion of the spindle motor 230 by a screw 234 in order to firmly fix the disk D to the spindle motor 230.

Further, although FIG. 5 shows a case in which a single disk D is mounted on the spindle motor 230, the present invention is not limited thereto. That is, one or more disks may be mounted on the spindle motor 230.

Further, in the case in which a plurality of disks D are mounted on the spindle motor 230, a ring shaped spacer may be disposed between the plurality of disks D in order to maintain an interval therebetween.

As described above, since the opening part 142 into which the elastic member 124 of the bracket device 120 is inserted is formed by the elastic support part 150, the elastic member 124 and the elastic support part 150 may be in contact with each other.

Therefore, since the elastic member 124 contacts the elastic support part 150, the contact area between the elastic member 124 and the press base 140 may be increased, as compared to the case in which the elastic support part 150 is not provided.

Therefore, when the elastic member 124 is inserted into the opening part 142, the deformation of the press base 140 is suppressed, whereby sealing may be firmly achieved.

In other words, the elastic support part 150 is formed by burring, such that the elastic member 124 contacts the elastic support part 150 at the time of inserting the elastic member 124 into the opening part 142, whereby the deformation of the press base 140 may be suppressed.

As set forth above, according to the embodiments of the present invention, the deformation of the press base may be reduced due to the elastic support part formed by burring.

While the present invention has been shown and described in connection with the embodiments, it will be apparent to those skilled in the art that modifications and variations can be made without departing from the spirit and scope of the invention as defined by the appended claims.

What is claimed is:

1. A base assembly comprising:
a bracket device connected to a head assembly in order to drive the head assembly for reading information from a disk and including an elastic member provided on one surface thereof, the elastic member having a terminal disposed in an inner portion thereof and connected to a main circuit board; and
a press base formed by press processing and having an opening part into which the elastic member is inserted,
wherein the press base includes an elastic support part forming the opening part and extended in a direction into which the bracket device is inserted to thereby increase a contact area with the elastic member.

2. The base assembly of claim 1, wherein the elastic support part is formed by burring.

3. The base assembly of claim 1, wherein an upper end portion of the elastic support part forming the opening part is rounded to allow the elastic member to be easily inserted thereinto.

4. The base assembly of claim 1, wherein the press base includes a screw coupling part disposed to be adjacent to the opening part and fixing the bracket device.

5. The base assembly of claim 1, wherein the elastic member is closely adhered to an inner surface of the elastic support part by compression force due to elastic deformation of the elastic support part in order to maintain air tightness.

6. A recording disk driving device comprising:
a base assembly including a bracket device having an elastic member provided on one surface thereof and a press base having an elastic support part extended in a direction into which the bracket device is inserted to thereby increase a contact area with the elastic member, the elastic member having a terminal disposed in an inner portion thereof and connected to a main circuit board;
a head stack assembly connected to the bracket device and rotatably installed on the press base; and
a spindle motor installed on the press base and having at least one disk mounted thereon.

7. The recording disk driving device of claim 6, wherein the elastic support part forms an opening part into which the elastic member is inserted and is formed by burring.

8. The recording disk driving device of claim 7, wherein an upper end portion of the elastic support part forming the opening part is rounded to allow the elastic member to be easily inserted thereinto.

9. The recording disk driving device of claim 7, wherein the elastic member is closely adhered to an inner surface of the elastic support part by compression force due to elastic deformation of the elastic support part in order to maintain air tightness.

10. The recording disk driving device of claim 7, wherein the press base includes a screw coupling part disposed to be adjacent to the opening part and fixing the bracket device.
